(19) United States
(12) Patent Application Publication
(10) Pub. No.: US 2013/0319391 A1
(43) Pub. Date: Dec. 5, 2013

(54) RECOVERY OF SILICON VALUE FROM KERF SILICON WASTE

(71) Applicant: Semlux Newco, Bedford, MA (US)

(72) Inventors: Alleppey V. HARIHARAN, Austin, TX (US); Jagannathan RAVI, Bedford, MA (US)

(73) Assignee: SEMLUX NEWCO, Bedford, MA (US)

(21) Appl. No.: 13/963,190

(22) Filed: Aug. 9, 2013

Related U.S. Application Data
(63) Continuation of application No. PCT/US12/24511, filed on Feb. 9, 2012.
(60) Provisional application No. 61/462,905, filed on Feb. 9, 2011.

(51) Int. Cl. C01B 33/023; B28D 5/00

(52) U.S. Cl. CPC C01B 33/023; B28D 5/0005
USPC 125/12; 423/350

(57) ABSTRACT

The present invention is for the recovery of maximum silicon value of kerf silicon waste, produced during the manufacture of silicon wafers by wire saw, diamond saw and chemical mechanical polishing, as high purity metallurgical silicon. This recovery is achieved by a process scheme that effects an initial removal of minor extrinsic metallic impurities but not the major silicon compound impurities, and followed, preferentially, by a direct metallurgical process to form elemental silicon. The recovered silicon is for use as feedstock for polysilicon manufacturing, as high purity polysilicon for PV application, and in metallurgical alloy manufacture.

### RELATED APPLICATIONS

This application is a continuation of PCT Patent Application No. U.S.12/24511, filed Feb. 9, 2012, and entitled “RECOVERY OF SILICON VALUE FROM KERF SILICON WASTE”, which application claims the benefit of U.S. Provisional Application No. 61/462,905, filed Feb. 9, 2011 and entitled “RECOVERY OF SILICON VALUE FROM KERF SILICON WASTE”, the entire content of which are incorporated herein by reference.

### INCORPORATION BY REFERENCE

All patents, patent applications and publications cited herein are hereby incorporated by reference in their entirety in order to more fully describe the state of the art as known to those skilled therein as of the date of the invention described herein.

### BACKGROUND OF THE INVENTION

The current mainstream method for producing high purity polysilicon for the electronic and photovoltaic (PV) industries is a combination of metallurgical and chemical. Starting from pure quartz (SiO₂), metallurgical grade silicon (MG-Si) is made by carbothermic reduction. This material is then converted into trichlorosilane (TCS, SiHCl₃) by reaction with HCl gas. After several purification processes via multiple distillations to remove all metallic and nonmetallic impurities present in MG-Si, the purified TCS gas is used to deposit ultra pure polycrystalline silicon. The processes, collectively called the Siemens Process, are very energy intensive.

The process flow to produce silicon wafers is the following:

MG-Si→TCS→Ultra Purified TCS→PolySi→Crystalline Si→Si Wafer.

Single or multi crystal silicon is grown from the polysilicon, leading to monocrystalline silicon ingot or multicrystalline silicon block. These are subsequently sliced into thin wafers by a wire saw process. This wire saw process produces significant silicon waste, known as kerf silicon waste, due to the cutting of the silicon ingot or block. While the current wafer thicknesses are in the range 300 microns, the equivalent kerf loss is 200 microns thick. The PV industry intends to reduce the thickness of the silicon wafer to 100 microns by year 2020, which will still cause an equivalent kerf silicon loss of 150 microns per wafer.

The Semiconductor and Photovoltaic industries produce significant quantities of kerf silicon waste during the wafer manufacturing operation. Slicing silicon ingot or block to make wafers is one of the most expensive and wasteful process steps in the silicon value chain, especially in the PV cell manufacturing industry. Kerf loss amounts to 40% to 50% of the silicon ingot, and which is presently discarded. This adds significantly to the silicon shortage of the PV industry. In addition, substantial amounts of the high purity silicon carbide powder used as abrasive in the wire saw process is also discarded. These waste mixtures end up in landfills. All these contribute to higher PV cell manufacturing costs and wasted energy.

The table below, based on industry polysilicon estimates and wafer thickness trends, shows the amount of silicon lost as kerf in the process of slicing ingots into wafers.

### Quantity of Silicon Kerf Waste, Polysilicon & Market Value

| | YEAR | | |
|---|---|---|---|
| PARAMETER | 2011 | 2012 | 2013 |
| Total Si Kerf Waste, mT/y | 79,000 | 91,000 | 100,000 |
| PolySi from Kerf, mT/y | 47,000 | 54,000 | 60,000 |
| Market Value, $ Billion | 2.8 | 2.7 | 3.0 |

A typical wire saw machine that caters to wafering, e.g., 50 tons of silicon ingots per year, may also require $150,000-$250,000/year for the SiC abrasives and silicon waste disposal costs. The semiconductor and solar industries cannot afford to dispose off such valuable materials without environmental concerns.

From the wire saw wafering process, large quantities of a slurry consisting of an organic cutting fluid, typically polyethylene glycol (PEG), admixed with the silicon carbide abrasive used for sawing the wafer, material from the saw wire, typically brass-coated iron and steel, and fine silicon powder are formed. The kerf silicon waste or kerf waste comprises the solids left behind after the maximum useable recovery of PEG and SiC from the slurry. Because the kerf is the result of sawing crystal-grown very high purity silicon, it will not have the type or amount of metallic and nonmetallic impurities present in metallurgical grade (MG)-Si. The final kerf silicon residue from the ingot wafer sawing/slurry recycle processes is estimated to be a mixture with only the abrasive SiC and carrier wire, typically Fe with traces of metallic and nonmetallic impurities and the carrier fluid. The particle size of this mixture is in the range 1-20 microns. Typical kerf waste composition is ˜60% Si-35% SiC-5% Fe, 0.1-0.2% Cu and Zn, and traces of metals from the finishing stages of the slurry recovery operation.

There is no practical process in the industry to recover silicon from the kerf waste and produce high purity silicon at competitive costs. The few development efforts such as the project RE-Si-CLE [ENK5-CT2001-00567 (2002-04)], iodide transport [PCT/US2009/040261], melt refining [Photovoltaic Specialists Conference, June 2010], etc. are academic in that industrialization is challenging or impractical. Kerf material pretreatment procedures [USPTO Applications 20100163462 and 20100284885] attempt near complete separation of kerf silicon from SiC and metal impurities; however, the Si purity is insufficient for PV applications. The more direct gas phase conversion of kerf silicon waste through TCS and Siemens deposition process [US Patent Application 20100032630] represents a different approach to very high purity polysilicon.

Innovative technologies to utilize recoverable sources of polysilicon and produce the right quality feedstock material at the right cost will have a major impact on the photovoltaic industry whose growth demand and growth potential are very dependent on the availability of polysilicon.

### SUMMARY

It is an object of the invention to provide a viable and practical industrial process and technology to recover kerf silicon powder waste into a form that has an appropriate level of purity for use as silicon feed stock for different applications. It is a further object to provide a process and technology that will maintain the intrinsic high purity of the kerf silicon.

It is another object of the invention to provide a practical process scheme for the recovery and consolidation of the silicon on a commercially useful production level.

In one aspect, a direct silicon recovery process is provided that recovers the kerf silicon along with the Si content of the associated SiC from the Si+SiC kerf powder mix and the Si is coalesced into a melt which solidifies. The methodology produces usable polysilicon at costs and energy consumption less than by the current methods, while also alleviating or removing the environmentally deleterious kerf silicon disposal.

The process includes a physico-chemical head-end treatment of the kerf silicon waste material to remove extrinsic metal impurities added during the wire saw and slurry recovery operations. This is followed by a direct metallurgical conversion of the purified kerf waste mix of Si+SiC into silicon.

High purity silicon is realized from the high quality silicon waste very effectively through a direct metallurgical process that effects the melting of the Si content and reduction of its SiC content to Si. It will produce a very high purity kerf-derived Metallurgical Grade silicon (KMG-Si) product.

The kerf silicon, apart from the SiC, Fe and a few metallic contaminants (Cu, Zn), is essentially very pure Si in quality, since it was derived from ultra high quality silicon crystal ingot grown from high purity polysilicon. It will have no intrinsic metallic and nonmetallic impurities, and especially no dopant impurities such as B and P. The material will have minor surface oxidation from the slurry recovery process.

The abrasive SiC in the kerf residue is also of very high purity and is made purer still with the removal of metallic impurities. The other major constituent “impurities” in the SiC abrasive are free carbon, silicon and silica (SiO₂). The present process surprisingly takes advantage of these impurities to provide a high purity silicon in an amount greater than the initial silicon present in the kerf waster. These heretofore undesirable “impurities” are all utilized as desirable constituents for the metallurgical silicon recovery process.

In certain embodiments, the process employs a nominal physical and chemical dissolution process to remove the Fe, Cu, Zn and other metallic impurities from the kerf waste, then utilizes the cleaned kerf material mix of Si and SiC and superficial oxide, to convert to high purity metallurgical silicon in a submerged arc furnace according to well established process. Unlike all reported previous schemes of silicon recovery, there is no need to remove or reduce SiC from the mix. In fact, its presence is advantageous to the kerf refining process.

Unlike the conventional MG-Si process, the process of this description will need no silica feed or carbon/graphite reductant. The silica equivalent of the SiC needed for the metallurgical reaction is formed in the kerf mix by oxidizing appropriate quantity of kerf Si by exposure to heated air, or less preferably, high purity silica added to the kerf mix. Thus, the typical, major and minor impurity contributions from the silica and reductant are completely eliminated. This helps to maintain the intrinsic purity of the Si from the kerf waste, and provide a product Si of very high purity, free from dopant elements and other metal impurities.

The metallurgical processes pertinent to the present invention are:

Si(s,in kerf)→Si(l)

(melt and coalesce) [1]

SiC(s,in kerf)+0.5SiO₂(s)→1.5Si(l)+CO(g)

(metallurgical reduction). [2]

### BRIEF DESCRIPTION OF THE DRAWING

This invention is described with reference to the following drawings that are presented for the purpose of illustration only and are not intended to be limiting of the invention.

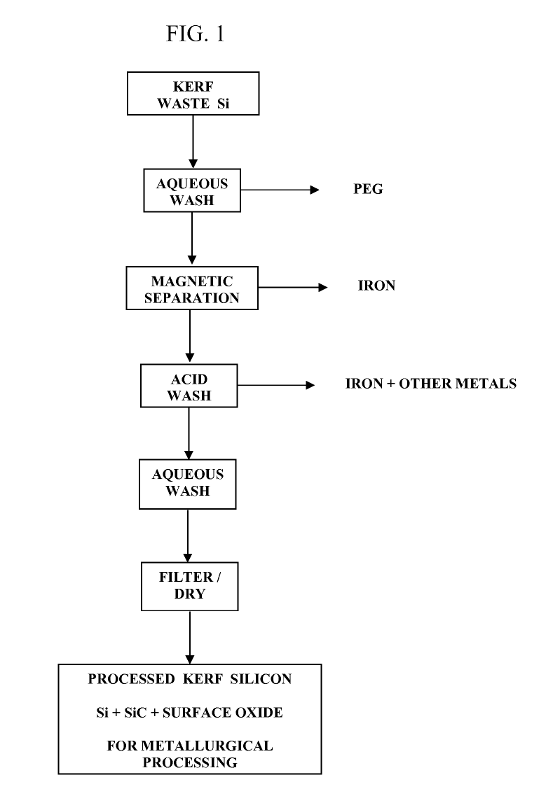

The reference process flow sheet to convert kerf waste silicon to processed kerf material for further metallurgical processing is described in FIG. 1.

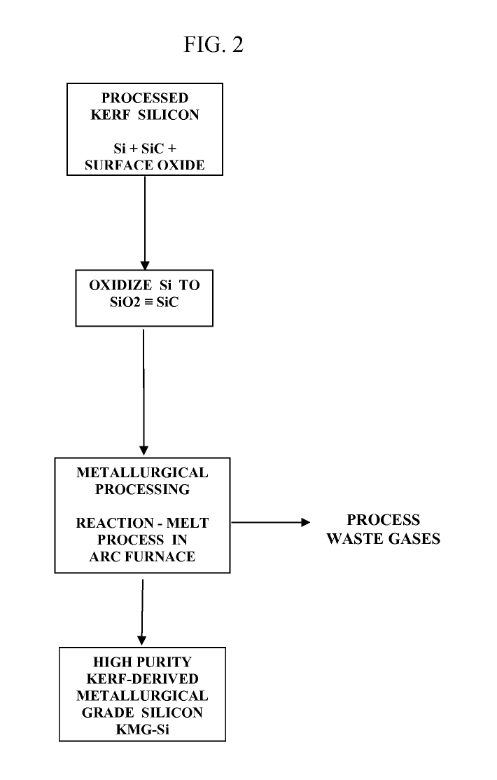

A process scheme according to one or more embodiments of the present invention to convert processed kerf silicon with in-situ silica formation to high purity kerf-derived Metallurgical Grade silicon (KMG-Si) is shown in FIG. 2.

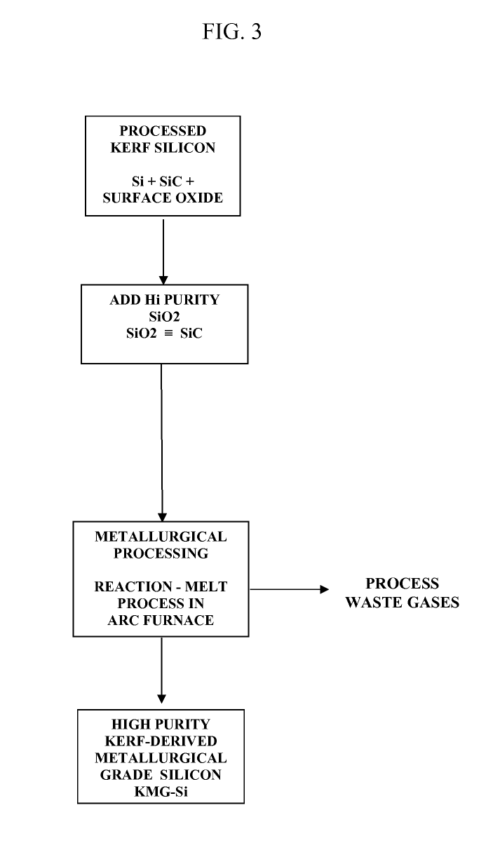

A process scheme according to one or more embodiments of the present invention to convert processed kerf silicon with added silica to high purity kerf-derived Metallurgical Grade silicon (KMG-Si) is shown in FIG. 3.

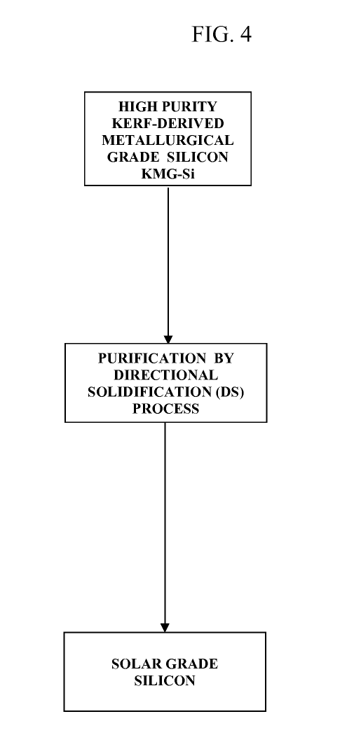

A process flow sheet of the present invention to process high purity kerf-derived Metallurgical Grade silicon (KMG-Si) to solar grade silicon through metallurgical route is shown in FIG. 4.

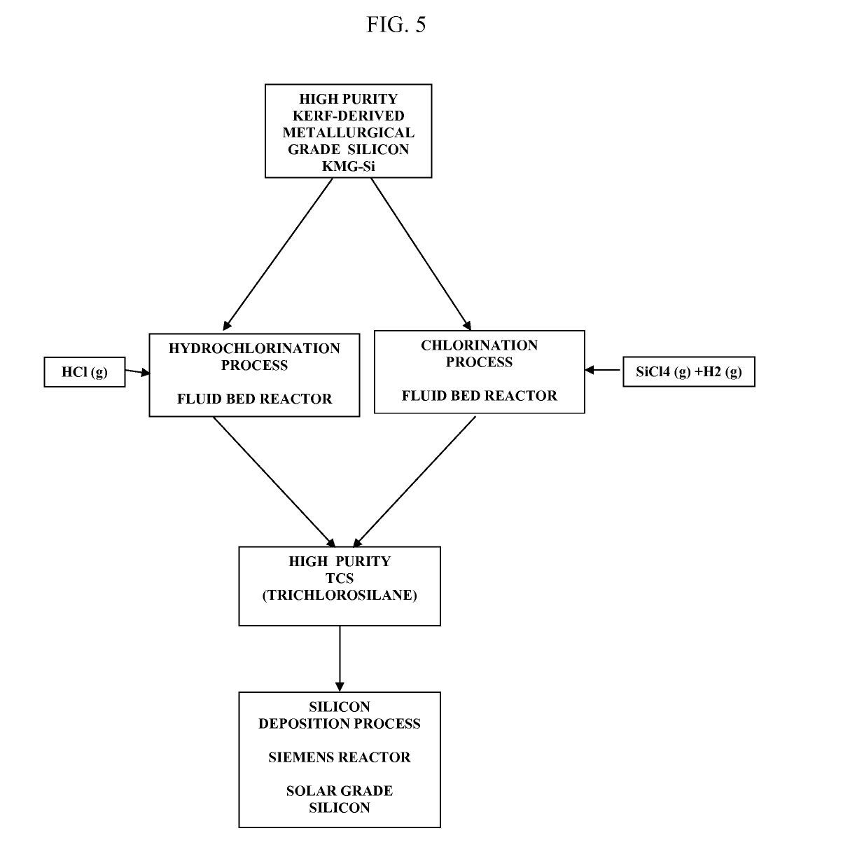

A process flow sheet of the present invention to process high purity kerf-derived Metallurgical Grade silicon (KMG-Si) to solar grade silicon through trichlorosilane route is shown in FIG. 5.

### DETAILED DESCRIPTION

The challenge in recycling the kerf silicon is to produce silicon of the required purity, cost and environmental impact compared with current feedstock production. The most practical process for the silicon recovery is to recycle the material to the beginning of the Si process cycle (MG-Si formation) where it will integrate seamlessly with established industrial and logistical operations. With the high intrinsic purity of the kerf Si and SiC, it can be guaranteed that the silicon product from such a kerf-recovery process will be immensely higher in purity than any level that can be achieved from the currently practiced MG-silicon process.

The metallurgical route is a process technology very well practiced by the industry for >50 years. If such a process can be appropriately adapted to utilize the kerf silicon waste, the recovered silicon will make a very significant contribution to the PV feedstock industries from material quantity and material cost saving.

In one aspect, a method of converting kerf silicon waste to high purity kerf-derived Metallurgical Grade silicon includes providing a kerf silicon waste comprising silicon (Si) and an abrasive reducing agent selected from the group consisting of silicon carbide, carbon and mixtures thereof; introducing to the kerf silicon waste a desired amount of silicon oxide in proportion to the amount of abrasive reducing agent in the kerf silicon waste to provide a kerf material mixture; treating the kerf material mixture to reduce the silicon oxide to silicon and thereby consume the reducing agent in the kerf material mixture and provide a kerf-derived Metallurgical Grade silicon.

In one or more embodiments, the further include separating additional impurities from the kerf silicon waste using one or more of the following processes:

reducing a carrier fluid from the kerf silicon waste;

reducing metallic impurities from the kerf silicon waste; and

washing and drying the kerf silicon waste.

In one or more embodiments, the carbon content of the kerf-derived Metallurgical Grade silicon is less than 100 ppm.

In one or more embodiments, the silicon oxide includes silica.

In one or more embodiments, introducing to the kerf silicon waste a desired amount of silicon oxide includes one or more of the following:
oxidizing a portion of the silicon content of the kerf material mixture to silicon oxide; and/or
adding a high purity SiO₂ to the kerf material mixture.

In one or more embodiments, the kerf silicon waste includes high purity silicon, residual wire saw slurry, and wire saw material.

In one or more embodiments, the residual wire saw slurry includes a liquid carrier and the abrasive reducing agent.

In one or more embodiments, the liquid carrier is selected from the group consisting of polyethylene glycol, water and oil and mixtures thereof.

In one or more embodiments, the residual wire saw material is selected from the group consisting of iron, steel, stainless steel, brass coated iron and brass coated steel and combinations thereof.

In one or more embodiments, separating the kerf silicon waste includes washing with high purity water to remove water soluble impurities of the kerf silicon waste.

In one or more embodiments, separating the kerf silicon waste includes washing the kerf silicon waste from oil-based carrier fluid wire saw process with an organic-based liquid extractant to remove oil.

In one or more embodiments, magnetic metallic impurities in the kerf silicon waste are reduced by a magnetic separation system.

In one or more embodiments, metallic impurities in the kerf silicon waste are reduced by treating with acid mix to dissolve the metals.

In one or more embodiments, the conversion of kerf material mixture to kerf-derived Metallurgical Grade silicon is carried out through a metallurgical reduction process.

In one or more embodiments, the metallurgical reduction process is performed primarily in an electric arc furnace.

In one or more embodiments, the metallurgical reduction process is performed at temperatures in the range 1500 C to 2000 C.

In one or more embodiments, the metallurgical reduction process produces kerf-derived Metallurgical Grade silicon having a purity of greater than 99.9 wt % Si.

In one or more embodiments, the metallurgical reduction process produces kerf-derived Metallurgical Grade silicon having a purity of greater than 99.99 wt % Si.

In one or more embodiments, the kerf-derived Metallurgical Grade silicon includes dopant levels of less 1 ppm for Boron and less than 1 ppm for Phosphorus.

In one or more embodiments, the kerf-derived Metallurgical Grade silicon is further refined using a directional solidification process.

In one or more embodiments, kerf-derived Metallurgical Grade silicon includes less than 1 ppm of any impurity.

In one or more embodiments, the method further includes reacting the kerf-derived Metallurgical Grade silicon to form trichlorosilane using a process selected from the group consisting of hydrochlorination and chlorination and combinations thereof.

In another aspect, a method of making a silicon wafer includes:
providing a kerf-derived silicon ingot prepared as described herein; and
cutting a wafer from the ingot, wherein a wafer is obtained without an additional melt and crystal growth step.

As used herein “high purity” silicon and “high purity” silica refers to materials having less than 1 ppm of any impurity.

As used herein “metallurgical grade” silicon refers to materials having less than 1% impurities.

As used herein “silicon oxide” refers to a oxygen-containing silicon having a range of oxygen, e.g., SiOₓ. In preferred embodiments, the silicon oxide is silicon dioxide (SiO₂), which provides a known oxygen level in the kerf silicon mixture.

With reference to FIG. 1, the basic steps of a preferred method for the kerf recovery process are as follows: The kerf silicon waste, contaminated with SiC, Fe, trace metallic and nonmetallic impurities, polyethylene glycol (PEG) and water is washed with high purity water to remove PEG. The wash system, which can be co-current or counter current column type or other, will incorporate a magnetic separator to remove most of the elemental Fe impurity from the kerf waste. The resulting water-based slurry, which will contain SiC, Si and traces of metallic and nonmetallic impurities will be put through an acid wash at ambient temperature. The purpose of this step is to dissolve traces of extrinsic metallic impurities from the kerf mix. The wash acid is preferably a mix of hydrochloric acid to enable the dissolution of iron, zinc and other metals, and nitric acid to oxidize metals such as copper to enable their dissolution. The slurry, after the acid wash, is filtered and washed with clean water to provide a clean wet cake of silicon with 20-40% SiC and free of metallic and nonmetallic impurities. The cake is dried at 150°-200° C. in a clean air environment to produce a dry cake of the same.

### Conversion of Kerf Si+Sic Mix To High Purity Kerf-Derived Metallurgical Grade Silicon (Kmg-Si)

Industrially, metallurgical silicon is manufactured by reduction of silica (SiO₂) with carbon in a submerged electrodes arc furnace. The overall metallurgical reaction is

SiO₂(s)+2C(s)=Si(l)+2CO(g). [3].

The process, however, occurs in complex multistages at different hot zones of the arc furnace (reactions [4] through [8]).

Liquid silicon is produced in the inner hot zone, where the temperature is 1800°-2100° C., according to the following chemical schemes:

SiO₂(s)+3C(s)=SiC(s)+2CO(g) [4]

2SiO₂(l)+SiC(s)=3SiO(g)+CO(g) [5]

SiO(g)+SiC(s)=2Si(l)+CO(g) [6].

The high temperature in the inner zone allows formation of a high proportion of SiO (g) in this zone according to reaction [5]. High partial pressure of SiO (g) is indispensable for the formation of Si (l) according to reaction [6].

In the outer zone, where the temperature is below 1800° C., SiO (g) emanating from the inner zone encounters and react with free carbon to form SiC (s) according to reaction [7]. The SiO (g) also undergoes disproportionation reaction according to reaction [8]. The silicon carbide SiC (s) and Si (l) forms in a matrix of SiO₂ (s,l).

SiO(g)+2C(s)=SiC(s)+CO(g) [7]

2SiO(g)=Si(l)+SiO₂(s) [8].

Thus, SiC is an important intermediate in the metallurgical reduction process of converting SiO₂ into Si. While the overall pertinent reaction for the present invention is

SiO₂(s)+2SiC(s)=3Si(l)+2CO(g). [9].

The mix of Si+SiC+SiO₂, therefore, provides multiple reaction paths for the formation of the critical SiO (g) from high temperature equilibria of reactions [5] and [8]. In addition, the melting of Si from the mix will also result in material porosity that enables the SiO (g) to diffuse, migrate and react with SiC (s) to form Si (l).

Thus, confining the reduction of SiO₂ by SiC according to reaction scheme [9] is a much more efficient process with relatively lower emission of gaseous species per silicon equivalent compared to the conventional reduction of SiO₂ with carbon, reaction [3]. If the concentration of SiO₂ is kept high, the silicon carbide content of the mix can be completely eliminated, thus lowering the carbon contamination in the formed Si.

The present invention will utilize the SiC impurity in the kerf waste and reaction [9] to efficiently recover the Si from the kerf waste. The kerf silicon recovery process, thus, is a total process to recover the silicon values from its Si and SiC contents. It also requires significantly less electrical energy for the overall Si recovery process, from typically 13 kWh/kg Si for regular MG-Si production to ˜6 kWh/kg for 50% Si+50% SiC mix and ˜2 kWh/kg Si for 90% Si+10% SiC mix (with appropriate equivalent added SiO₂).

Two process methodologies are described. The first process involves in-situ creation of SiO₂ equivalent in molar concentration to the SiC content of the kerf waste, which is illustrated in the process flow diagram in FIG. 2.

In this process, a part of the silicon content of the purified kerf mix will be oxidized at high temperature to form controlled amount of SiO₂. At the end of this process the kerf mix contains Si+SiC+formed amount of SiO₂.

Table 1 gives the theoretical quantity of Si to be oxidized for equivalency to the SiC content.

TABLE 1
In-Situ Oxidation of Silicon
Total Si + SiC Weight 100 kg

| | | | Si equiv. | Total Si |
|---|---|---|---|---|
| Si kg | SiC kg | SiO₂ needed kg | to oxidize kg | formed kg |
| 100 | 0 | 0.0 | 0 | 100.0 |
| 90 | 10 | 7.5 | 3.5 | 97.0 |
| 80 | 20 | 15.0 | 7.0 | 94.0 |
| 70 | 30 | 22.5 | 10.5 | 91.0 |
| 60 | 40 | 30.0 | 14.0 | 88.0 |
| 50 | 50 | 37.5 | 17.5 | 85.0 |
| 40 | 60 | 45.0 | 21.0 | 82.0 |
| 30 | 70 | 52.4 | 24.5 | 79.0 |
| 26 | 74 | 55.4 | 25.9 | 77.8 |

The second process involves the addition of pure SiO₂ equivalent to the SiC content, as is illustrated in the process flow diagram of FIG. 3.

In this process, quantified amount of high purity SiO₂ will be added to the purified kerf mix, rather than oxidizing a quantity of the silicon in the kerf mix. At the end of this process the kerf mix will contain Si+SiC+added amount of SiO₂.

Table 2 gives the quantity of SiO₂ to be added for equivalency to the SiC content.

TABLE 2
Add SiO₂
Total Si + SiC Weight 100 kg

| | | | Si equiv | Total Si |
|---|---|---|---|---|
| Si kg | SiC kg | SiO₂ to add kg | of SiO₂ kg | formed kg |
| 100 | 0 | 0.0 | 0 | 100.0 |
| 90 | 10 | 7.5 | 3.5 | 100.5 |
| 80 | 20 | 15.0 | 7.0 | 101.0 |
| 70 | 30 | 22.5 | 10.5 | 101.5 |
| 60 | 40 | 30.0 | 14.0 | 102.0 |
| 50 | 50 | 37.5 | 17.5 | 102.5 |
| 40 | 60 | 45.0 | 21.0 | 103.0 |
| 30 | 70 | 52.4 | 24.5 | 103.6 |
| 26 | 74 | 55.4 | 25.9 | 103.8 |

Method 1 intrinsically maintains the high purity nature of the kerf waste containing Si+SiC+SiO₂. The quality of the SiO₂ added to the kerf waste in Method 2 requires it to be >99% pure to ensure high purity for the resulting kerf-derived Metallurgical Grade silicon.

Methods 1 and 2 may be combined to supplement SiO₂ to the desired level if required.

With either method it is recommended to use a nominal 5-10 weight percent excess of the silica content with respect to the SiC stoichiometry in the (Si+SiC+SiO2) mix to ensure complete reaction of the SiC with SiO2 in the arc furnace process. This will ensure carbon content in the formed liquid silicon to no more than the saturation limit of approximately 35 ppmw.

In some embodiments, the SiO₂ content (and the content of SiC), e.g., Si, O and C content, can be determined prior to metallurgical processing. Further adjustments can be made to the SiO₂ just prior to metallurgical processing to ensure that sufficient SiO₂ is present.

With either method, the material is to be mixed well to homogenize the ingredients prior to use as a feed to the arc furnace. While the mix powder is an appropriate feed to the arc furnace, the mix may be formed into briquettes, granules or pellets for ease of material loading and to provide uniform distribution of the three component (Si+SiC+SiO₂) solid material to the hot zone for efficient reaction.

The purity of the kerf-derived Metallurgical Grade silicon (KMG-Si) from the process will be >99%, even >99.99% if the kerf material is cleaned from extrinsic impurities. The level of dopants (B+P) would also be <1 ppmw. If untreated (except for bulk Fe removal) kerf material is utilized, the product Si material purity is expected to be >98%, even >99.7%, with <1 ppmw dopant impurities.

The silicon product from the process of this invention is expected to have a material purity suitable for use as highly upgraded Metallurgical Grade silicon. With a nominal melt refining process, such as melting in oxidic crucible and directional solidification casting, the silicon will be suitable for direct use as PV feedstock.

In other processes, abrasive carbons such as diamond are used in the wafering process. Carbon abrasive can be used as the abrasive reducing agent in processes similar to those described above, relying for example, on reduction pathways such as described in [4]. It will be appreciated that the silicon yield will be lower in that the abrasive carbon is not a silicon source.

### Example 1

### Pretreatment of Kerf Silicon

Kerf silicon typically contains 50-60% Si, 25-30% SiC, 5-10% oxidized Si, 4-5% Fe, approximately 0.1% Cu and Zn and traces of other metallic impurities added from the slurry recovery and kerf silicon separation processes. Typical levels of impurities in kerf Si are: Fe˜4-5%, Al 250-300 ppm, Ca 500-700 ppm, Ti 5-100 ppm,

Mn 100-200 ppm, Na 0.1%, Cu ˜0.2%, Zn ˜0.1%, traces of alkali metals.

B<2 ppm, P ˜0 ppm. Almost all of these impurities are extrinsic to the silicon, since the latter was derived from crystal grown ingots. As such, the levels of these impurities can be controlled and reduced by proper care in the slurry recovery and kerf separation processes. They can also be removed by appropriate pretreatment of the kerf silicon waste.

Since these impurities are present as metals or their oxides, acid extraction is the most appropriate pretreatment process. In an example the kerf silicon was treated by leaching the impurities with a dilute acid mix of HCl and HNO₃, and washed with DI water. The total residue from this process (Si+SiC+Oxidized Si) analyzed the following: Fe 100 ppm, Cu 120 ppm, Zn 20 ppm, Al 50 ppm, Ca 20 ppm, and alkali metals 500 ppm, with leaching efficiencies in the range 80% to >95%. Typically the process is reactive mass transfer from the pores of the kerf silicon waste powder into the leachant solution and the reduction of the impurities can be considered to depend upon the number of acid leach treatments. As such, multiple pretreatment washes are expected to provide a treated kerf silicon material with extrinsic impurities such as Fe <1 ppm, Cu<0.5 ppm, Zn<0.1 ppm, Al<1 ppm, and transition metals<1 ppm. Such acid treatments are not expected to reduce the intrinsic impurities contained in the Si or SiC of the treated kerf silicon material.

### Comparison of Pretreated Kerf-Derived Mg-Silicon (Kmg-Si) With Commercial Mg-Si (Mg-Si) and Upgraded Mg-Si (Umg-Si)

The metallic impurity content of such pretreated kerf silicon is significantly better than that of MG-Si and UMG-Si. MG-Si material is typically 98%-99% pure., with levels of impurities: Fe 1550-6500 ppm, Al 1000-4350 ppm, Ca 245-500 ppm, Ti 140-300 ppm, C 100-1000 ppm, O 100-400 ppm, B 40-60 ppm, P 20-50 ppm and traces of such impurities as Mn, Mo, Ni, Cr, Cu, V, Mg and Zr. The target composition for the UMG-Si is typically Fe<150 ppm, Al<50 ppm, Ca<500 ppm, Cr<15 ppm, Ti<5 ppm, B<30 ppm and P<15 ppm. Secondarily purified UMG-Si has Fe<50 ppm, Al<50 ppm, Ca<50 ppm, Ti<5 ppm, B<7 ppm and P<7 ppm.

In comparison, the metal contents of the pretreated kerf silicon, not including in its SiC content, are generally <1 ppm for most typical metals, and with dopant levels of <0.2 ppm for B and ˜0 ppm for P.

The SiC normally used for the wire saw process is the high purity type. It typically analyses >99.3% SiC, free Si 0.2%, SiO2 0.3%, free C 0.1%, Fe 0.05%, Al 0.01% and Ca 0.01%. In its manufacturing process SiC will not contain any phosphorous impurity. High purity SiC does not contain any significant quantity of boron, another potential silicon dopant element. In the arc melt metallurgical process such boron impurity, if it is contained in the SiC, will end up mostly in the metallurgically formed silicon. The overall boron level in such formed silicon, however, can be controlled to the desired level by appropriately choosing the percentage of such SiC in the mix with the intrinsically pure silicon and oxidized silicon. The boron level in the kerf-derived Metallurgical Grade silicon (KMG-Si) will also be reduced in a subsequent directional solidification purification process.

It is anticipated that the silicon from the arc melt processing of the mix of pretreated kerf silicon, SiC and composition—adjusted SiO₂ will have most metallic impurities of the order of low 1-2 ppm, Fe˜100-150 ppm, Al ˜25 ppm and Ca ˜25 ppm, and with dopant impurities of B<0.5 ppm and P ˜0 ppm. Further purification of this material by a controlled directional solidification (DS) process is expected to provide solar grade Si with purities >99.9995%, with B<0.3 ppm, a level acceptable for solar grade silicon.

Refining the Silicon from Pretreated and Submerged Arc Melted Kerf-Derived Metallurgical Grade Silicon (Kmg-Si)

Significant purification of the silicon material would occur during the directional solidification process (FIG. 4 flow sheet) since the solid to liquid partition coefficients for the metallic impurities are: >10⁻⁵ for Ti, V, Cr, Fe, Co, Ni, Zn, Zr, Nb, Mo, Ta, W, etc, >10⁻⁴ for Cu, >10⁻² for Al, etc. Such levels of decontamination can be achieved in typical Czochralski (CZ) crystal growth process for silicon. The effective partition coefficients in industrial DS process have values typically of the order of >10⁻³. Even such values will provide decontamination factors for the kerf-derived Metallurgical Grade silicon (KMG-Si) with a single directional solidification process with metal impurities of <1 ppm.

Only limited purification is possible for non metals such as O, C, B and P in the directional solidification process. P is not pertinent since the pretreated kerf silicon does not have this impurity. Any trace impurity of P, if present in the kerf silicon or SiC, will also be removed in the arc melt process of forming KMG-Si. The level of boron in the kerf-derived Metallurgical Grade-Silicon (KMG-Si) material is expected to be <0.5 ppmw, which will result in a DS processed silicon with boron impurity of <0.3 ppmw (for boron partition coefficient of 0.8).

It should be noted that the DS step will not only purify the silicon but also transforms its crystal structure from polysilicon to muticrystalline silicon.

The use of the directional solidification process as a means to further reduce impurity levels thus creates the opportunity to streamline downstream operations for the production of solar cells. The PV industry uses polysilicon chunks or granules too melt and grow silicon ingots or blocks that are then sawn into wafers for subsequent processing. As mentioned previously, multicrystalline silicon blocks are grown using the DSS process. Since the PV silicon manufacturing of the present invention already incorporates the DSS step, another downstream melt and growth of silicon blocks is typically unnecessary. Hence, the silicon product, produced by this invention can bypass the ingot growth step and is thus suitable for wafering operations.

### VARIATIONS OF THE PRESENT INVENTION

Although the present invention refers to kerf silicon waste from PEG-based wire saw process that utilizes SiC abrasive, the process is adaptable to other wire saw processes, such as with use of SiC or diamond abrasive in oil- or water-based systems. In such cases the residual oil from the kerf silicon waste can be extracted with an organic extractant, followed by the process scheme described in this invention. The diamond residue will not need to be separated from the silicon, since it acts as a source of carbon for the metallurgical reduction process.

Even higher purity KMG-Si is possible by reducing the amount of SiC in the treated kerf mix that is fed into the arc furnace and thus taking advantage of the intrinsic high purity of the silicon powders to the greatest extant possible.

This invention is also applicable to silicon lost in the backgrinding and chemical mechanical polishing steps on semiconductor and PV wafers.

While this invention describes a method to convert kerf silicon to solar grade silicon by a combination of a submerged arc melt process followed with a single DSS process, the silicon material from the arc melt process is also applicable for hydrochlorination with HCl gas or chlorination with SiCl₄ and H₂ gases to form trichlorosilane (FIG. 5 flow sheet). The purity of such trichlorosilane before further processing will be significantly better than the currently produced material. This will make it feasible to reduce the number of distillation stages to produce high purity solar grade polysilicon or very high purity electronic grade polysilicon.

While the process of this invention will utilize conventional submerged arc furnaces with carbon electrodes, other high temperature furnace systems such as with induction heating, etc. may be practical for the type of reaction feed to produce silicon.

Other and various embodiments of the methodology described in this invention will be evident to those skilled in the art from the specification of this invention.

What is claimed is:

1. A method of converting kerf silicon waste to high purity kerf-derived Metallurgical Grade silicon comprising:
a. providing a kerf silicon waste comprising silicon (Si) and an abrasive reducing agent selected from the group consisting of silicon carbide, carbon and mixtures thereof;
b. introducing to the kerf silicon waste a desired amount of silicon oxide in proportion to the amount of abrasive reducing agent in the kerf silicon waste to provide a kerf material mixture;
c. treating the kerf material mixture to reduce the silicon oxide to silicon and thereby consume the reducing agent in the kerf material mixture and provide a kerf-derived Metallurgical Grade silicon.

2. The method of claim 1, further comprising separating additional impurities from the kerf silicon waste using one or more of the following processes:
a. reducing a carrier fluid from the kerf silicon waste;
b. reducing metallic impurities from the kerf silicon waste; and
c. washing and drying the kerf silicon waste.

3. The method of claim 1, the carbon content of the kerf-derived Metallurgical Grade silicon is less than 100 ppm.

4. The method of claim 1, wherein the silicon oxide comprises silica.

5. The method according to claim 1, wherein introducing to the kerf silicon waste a desired amount of silicon oxide comprises one or more of the following:
a. oxidizing a portion of the silicon content of the kerf material mixture to silicon oxide; and/or
b. adding a high purity SiO₂ to the kerf material mixture.

6. The method according to claim 1, wherein the kerf silicon waste comprises high purity silicon, residual wire saw slurry, and wire saw material.

7. The method according to claim 6, wherein the residual wire saw slurry comprises a liquid carrier and the abrasive reducing agent,

8. The method according to claim 6, wherein the liquid carrier is selected from the group consisting of polyethylene glycol, water and oil and mixtures thereof.

9. The method according to claim 6, wherein the residual wire saw material is selected from the group consisting of iron, steel, stainless steel, brass coated iron and brass coated steel and combinations thereof.

10. The method according to claim 2, wherein separating the kerf silicon waste comprises washing with high purity water to remove water soluble impurities of the kerf silicon waste.

11. The method according to claim 2, wherein separating the kerf silicon waste comprises washing the kerf silicon waste from oil-based carrier fluid wire saw process with an organic-based liquid extractant to remove oil.

12. The method according to claim 2, where magnetic metallic impurities in the kerf silicon waste are reduced by a magnetic separation system.

13. The method according to claim 2, wherein metallic impurities in the kerf silicon waste are reduced by treating with acid mix to dissolve the metals.

14. The method according to claim 1, wherein the conversion of kerf material mixture to kerf-derived Metallurgical Grade silicon is carried out through a metallurgical reduction process.

15. The method according to claim 14, wherein the metallurgical reduction process is performed primarily in an electric arc furnace.

16. The method according to claim 14, wherein the metallurgical reduction process is performed at temperatures in the range 1500 C to 2000 C.

17. The method of claim 14, wherein the metallurgical reduction process produces kerf-derived Metallurgical Grade silicon having a purity of greater than 99.9 wt % Si.

18. The method of claim 14, wherein the metallurgical reduction process produces kerf-derived Metallurgical Grade silicon having a purity of greater than 99.99 wt % Si.

19. The method according to claim 2, wherein the kerf-derived Metallurgical Grade silicon comprises dopant levels of less 1 ppm for Boron and less than 1 ppm for Phosphorus.

20. The method according to claim 1, wherein the kerf-derived Metallurgical Grade silicon is further refined using a directional solidification process.

21. The method of claim 20, wherein kerf-derived Metallurgical Grade silicon comprises less than 1 ppm of any impurity.

22. The method according to claim 1, further comprising reacting the kerf-derived Metallurgical Grade silicon to form trichlorosilane using a process selected from the group consisting of hydrochlorination and chlorination and combinations thereof.

23. A method of making a silicon wafer, comprising:
a. providing a kerf-derived silicon ingot prepared according to the method 20; and
b. cutting a wafer from the ingot, wherein a wafer is obtained without an additional melt and crystal growth step.
